(19) United States
(12) Patent Application Publication
(10) Pub. No.: US 2005/0137936 A1
(43) Pub. Date: Jun. 23, 2005

(54) Methods and systems for pricing products utilizing pricelists based on qualifiers

(75) Inventors: Pamela Roman, Birmingham, AL (US); Paul Fox, Birmingham, AL (US); Kathy Fox, Birmingham, AL (US)

Correspondence Address: BELLSOUTH CORPORATION, P.O. BOX 2903, MINNEAPOLIS, MN, 55402-0903, US

(73) Assignee: BellSouth Intellectual Property Corporation

(21) Appl. No.: 10/744,847

(22) Filed: Dec. 23, 2003

(51) Int. Cl. G06F 17/60

(52) U.S. Cl. 705/20

(57) ABSTRACT

Methods and systems are provided for pricing products based on qualifiers. A pricelist for a product being offered is defined. Defining the pricelist includes establishing one or more qualifiers for determining a price of the product and where each qualifier established for the pricelist is an attribute of the pricelist that results in a price variation for the product being offered. The qualifiers necessary to fully qualify a price of the product are encoded into a pricelist identifier referencing the price list. The pricelist is a price of the product once the qualifiers necessary to fully qualify a price have been established. The prices of the product may be differentiated and retrieved based on an unlimited number of qualifiers.

### FIELD OF INVENTION

The present invention relates generally to methods, systems, and computer-readable mediums for pricing products and services. More particularly, the present invention relates to varying pricing of telecommunications products utilizing pricelists based on one or more qualifiers.

### BACKGROUND OF THE INVENTION

Historically prices for telecommunication services were based on authorized tariffs where each tariff has a class of service. Tariffs are charges authorized by the Public Service Commission for telephone companies to use in providing products and services to the public. Tariffs are typically authorized based on the capital needs to build a facility and provide a service. For example a telephone company that only provides a POTS service may not be authorized to charge as much as a telephone company that provides data access. Over time telecommunication companies are selling more advanced services and the public has higher expectations. Today pricing is driven more by customer desires instead of cost to build facilities. For example customers desire creative products traditionally not offered such as wireless combined with wireline services.

One limitation to servicing the varied market desires of customers is the current billing systems have a limited number of data elements that can be used as price qualifiers. For example, current billing systems can only vary prices by Basic class of service, Rate Group, Tariff Exception Indicator, and Contract Identifier. These qualifications do not meet the needs for wireless, broadband, and other non-regulated products. Modifying current billing systems to include new data elements such as wireless, broadband is an expensive and complicated process.

Accordingly, there is a need for a method and system for varying prices of telecommunication products and services based on an unlimited number of qualifiers or data elements. It is with respect to these and other considerations that the present invention has been made.

### SUMMARY OF THE INVENTION

Embodiments of the present invention provide methods and systems for pricing telecommunications products and services utilizing pricelists based on qualifiers. A price qualifier is any data element that results in a price variation of the same product. The present invention provides the capability to vary prices for products by many different qualifications, such as customer qualifiers, location qualifiers and product qualifiers. The present invention also greatly simplifies the process of determining a price for a product for any application that requires price determination capability such as billing, ordering, or customer service for a telecommunications product provider. Products such as wireline, wireless, broadband service are varied in price by the present invention thereby offering customers market driven competitive pricing. Any product line where prices are differentiated, such as a cable communications product, a satellite communications product, and an Internet product, have applicable uses for embodiments of the present invention.

Multiple pricelists can be related to any product. The qualifiers are encoded to serve as the unique identifier for the pricelist. When a product is sold to a customer, the appropriate pricelist is selected based on the qualifiers for the specific customer. The unique identifier for the pricelist is associated with the product code for the product. Thereafter, other applications that need to acquire the price for the product are directed to the appropriate price with a need to use the qualifications to determine the price. Further, as the values of the qualifiers change, no system changes are needed in the applications that use the pricelist concept to determine the price of the product. As qualifiers are changed, only the applications that encode the qualifiers into pricelist identifiers need to be updated. Applications that utilize the result are not required to change.

One embodiment is a method of pricing products based on qualifiers. The method involves defining a pricelist for a product being offered. Defining the pricelist includes establishing one or more qualifiers for determining a price of the product. Each qualifier established for the pricelist is an attribute of the pricelist that results in a price variation for the product being offered. The method also involves encoding the qualifiers necessary to fully qualify a price of the product into a pricelist identifier. The pricelist identifier references the price list is a concatenated key of qualifiers that references the pricelist. The pricelist for a product is defined as the price of the product once the qualifiers necessary to fully qualify a price have been established. The method enables differentiation of prices for the product based on an unlimited number of qualifiers.

Another embodiment of the present invention may be a pricelist defined for at least one product that includes a data arrangement. The data arrangement includes a price for the product based on a number of qualifiers necessary to fully qualify the price. The number of qualifiers necessary to fully qualify the price is the number that accounts for fulfilling at least one of the qualifier categories of product, location, or customer type. The data arrangement also includes a pricelist identifier. The pricelist identifier in this embodiment is also a concatenated key of the qualifiers provided to other applications having a need to price the product. The data arrangement further includes a product code associating the product with the pricelist such that applications seeking a price of the product and having the product code and the pricelist identifier retrieve the price from the pricelist without knowledge of the qualifiers necessary to fully qualify the price.

Still another embodiment of the present invention may be a computer-implemented system for pricing products based on qualifiers. The system includes a server computer providing a graphical user interface operative to receive data to define at least one pricelist for a product being offered. Defining a pricelist includes establishing one or more qualifiers for determining a price of the product. The server computer is further operative to encode the qualifiers necessary to fully qualify a price of the product into a pricelist identifier referencing the pricelist. The system may also include a database operative to store at least one entry for the product in a data arrangement. The entries may include the qualifiers necessary to fully qualify a price of the product and or a pricelist including a fully qualified price associated with the product. The entries may also include the pricelist identifier referencing the pricelist and a product code representing the product.

These and other features and advantages, which characterize the present invention, will be apparent from a reading of the following detailed description and a review of the associated drawings. It is to be understood that both the foregoing general description and the following detailed description are exemplary and explanatory only and are not restrictive of the invention as claimed.

### BRIEF DESCRIPTION OF THE DRAWINGS

FIG. 1 is a simplified block diagram showing interaction between a product database/server system and a plurality of applications and systems according to an embodiment of the present invention.

FIG. 2 is a block diagram of the product database and server system according to an embodiment of the present invention.

FIG. 3 is a simplified block diagram illustrating qualifier categories of a product maintenance graphical user interface (PMGUI) and qualifiers received at the PMGUI and stored in the product database according to an embodiment of the present invention.

FIGS. 4A-4C are computer screen displays showing an illustrative PMGUI for creating and displaying pricelists according to an embodiment of the present invention.

FIGS. 5A-5B are computer screen displays showing an illustrative PMGUI for creating and displaying pricelists lines according to an embodiment of the present invention.

FIG. 6 illustrates a sample service order with billing instructions generated upon executing an order for a product priced by a pricelist according to an embodiment of the present invention.

FIG. 7 illustrates a flow diagram showing an illustrative routine for pricing products utilizing pricelists based on qualifiers according to an embodiment of the present invention.

### DETAILED DESCRIPTION

As described briefly above, embodiments of the present invention are directed to systems and methods for pricing products utilizing pricelists based on qualifiers. In the following detailed description, references are made to the accompanying drawings that form a part hereof, and in which are shown by way of illustrations, specific embodiments or examples. These embodiments may be combined, other embodiments may be utilized, and structural changes may be made without departing from the spirit or scope of the present invention. The following detailed description is therefore not to be taken in a limiting sense and the scope of the present invention is defined by the appended claims and their equivalents.

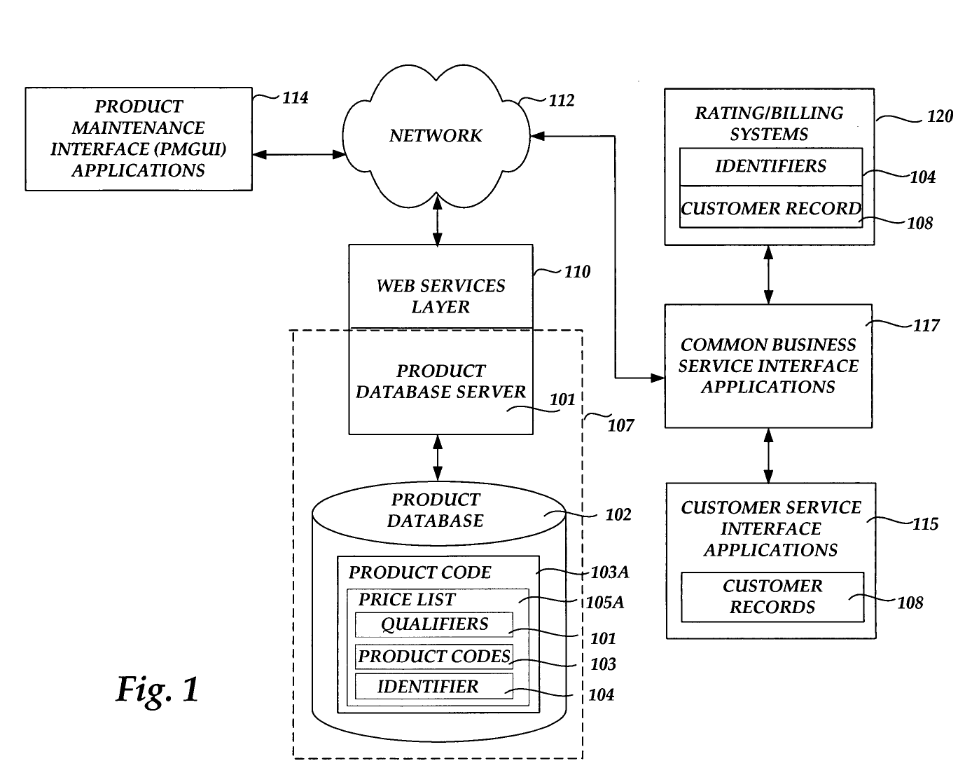

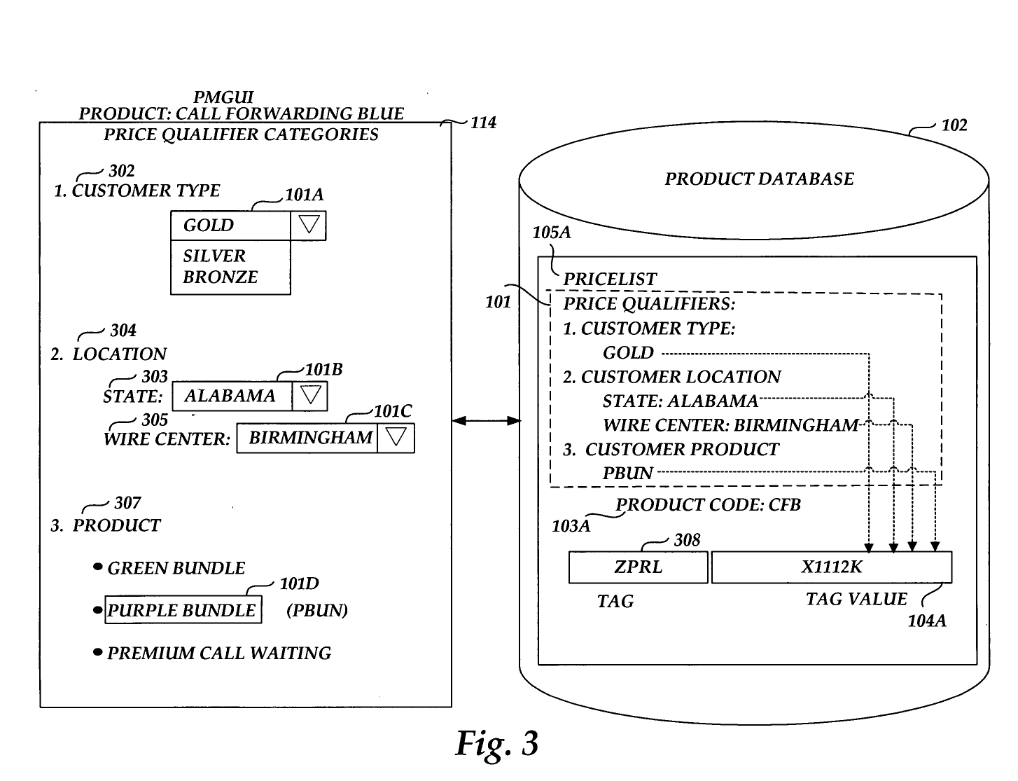

FIG. 1 is a simplified block diagram illustrating interaction between a product database system (PDS) 107 and a plurality of applications and systems via a web services layer 110 according to an embodiment of the present invention. The applications and systems include rating/billing systems 120 of various product providers, common business service applications (CBS) 117, customer service interface applications 115, and a product maintenance graphical user interface (PMGUI) 114. The rating/billing systems 120 and the customer service interface applications 115 have the capability to store customer records 108 containing customer data in their respective data stores. As will be described in greater detail below with reference to FIGS. 3-7, the PDS 107 includes an arrangement of data elements in the product database 102 that associate one or prices with a product based on qualifiers. Each product may be referenced by a product code 103. The prices are in the form of pricelists 105 where each pricelist is defined for at least one product and referenced by an identifier 104. Each identifier 104 is a concatenated key of the qualifiers 101 necessary to fully qualify the referenced price of the product in a pricelist 105.

The PDS 107 may interface with one or more general purpose computing systems and execute software program applications operative to provide price variations of products based on predetermined qualifiers 101, for example type of customer purchasing the product, location of the customer, and other products purchased by the customer. The qualifiers 101 may be of an unlimited quantity for each pricelist 105. As illustrated in FIG. 1, it should be appreciated that the associations between products and pricelists 105 is recursive such that multiple pricelists, for example 105A and 105B, may be defined for one product, as referenced by the product code 103A. Further, a single pricelist 105A may be defined for multiple products as referenced by the product codes 103. It should also be appreciated that a product may be defined by a group of other products serving as components of the product. As will be described below with respect to tables 1-3, the group of other products may have a single price point or may be component priced. Additionally each pricelist 105 may have a non-recurring, a recurring, and a usage component that may be referenced by the identifier 104 for the pricelist.

According to embodiments of the present invention the PDS 107 is employed for providing price variations for products based on qualifiers that demonstrate customer features, for example customer preferences and characteristics. The prices may be for the products of communication service providers such as wireless and wireline telecommunications service providers. According to embodiments of the present invention, rating/billing systems 120 of multiple communication services providers, such as a wireless and wireline communication services provider (wireline carrier), are illustrated for providing multiple communication services to subscribers such as wireless and local and long distance wireline services. As should be appreciated by those skilled in the art, the wireline carrier may operate a variety of telecommunications products such as wireline and digital data network communication services including conventional local and long distance wireline telephone services, Internet access services, digital data networks, wireline distributed computing networks, and other services. Also, as should be appreciated by those skilled in the art, the rating/billing systems 120 and common business service applications 117 may be components of communication services systems illustrative of conventional cellular communications networks and other wireless communications operating systems such as satellite-based and Internet-based wireless communications systems, ultra wideband wireless communications, low and medium range wireless communications such as wireless fidelity (WIFI) systems and the like.

According to embodiments of the present invention, the rating/billing systems 120 may include one or more general purpose computing systems, memory and software application programs operative to receive communication data record information associated with communication services such as wireless and wireline communication operated via a wireless or wireline carrier and to prepare periodic billing for communications services associated with service call data records, non-recurring charges, and recurring charges. For example, when a communication is sent or received via a communication services carrier, a call data record associated with the communication is received at the rating/billing system 120 of the carrier and is processed to determine whether or not a charge is associated with the communication data record. On a periodic basis, for example monthly, the rating/billing systems 120 of the carriers each generate a bill, or when shared generate a single bill, to subscribers of the carriers including charges for basic communication services subscribed to by the subscriber, non-recurring and recurring, and charges associated with individual usage, if required.

Prior to the generation of a bill, the pricelists 105 may be accessed by the rating/billing systems 120 utilizing pricelist identifiers 104 to reference pricelists for rating the products. The rating/billing systems 120 may communicate via a CBS application 117 that communicates with the PDS 107 via a network 112, such as the Intranet or the Internet, through a web services layer 110. The web services layer 110 provides an access messaging protocol for the CBS applications 117 and the PDS 107 to communicate with encoded information facilitating compatibility before receiving requests or sending responses over the network 112.

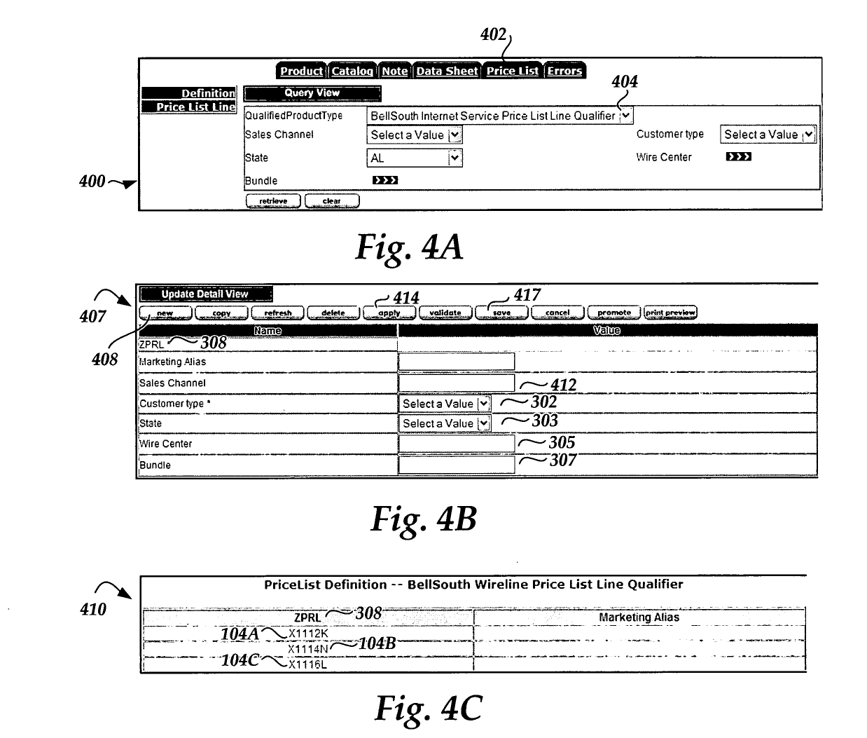

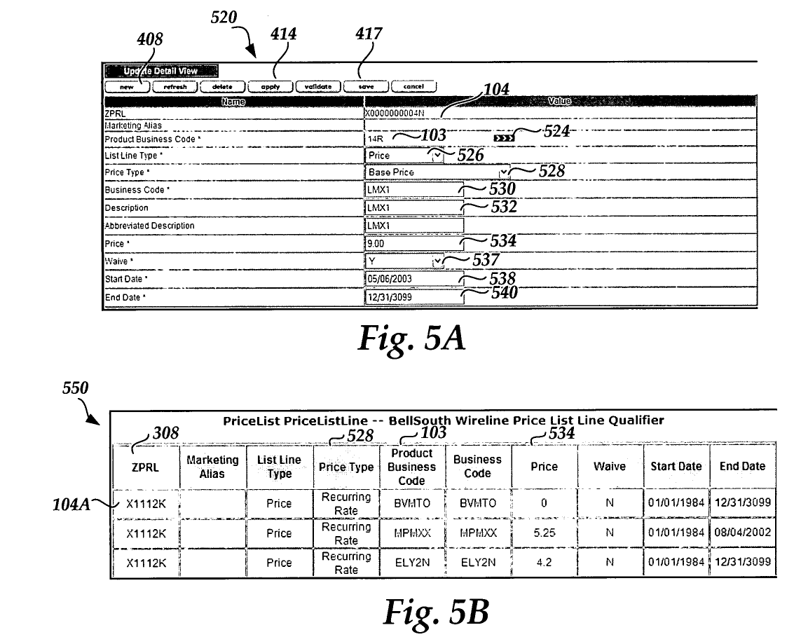

Other entities may also interact with the PDS 107. For example the customer service interface applications 115 may retrieve product information from the PDS 107 in order to respond to customer inquiries and/or orders for products. Furthermore, the PDS 107 may receive updates and additional pricelists via the PMGUI 114. For example a marketing representative may offer a new or enhanced product in response to a marketing promotion by defining a new or updated pricelist 105 for the new product in the PDS 107 via the PMGUI 114. The PMGUI applications 114 may also communicate over the network 112 through the web services layer 110. Additional details regarding interaction with the PDS 107 will be described below with respect to FIGS. 4A-5B.

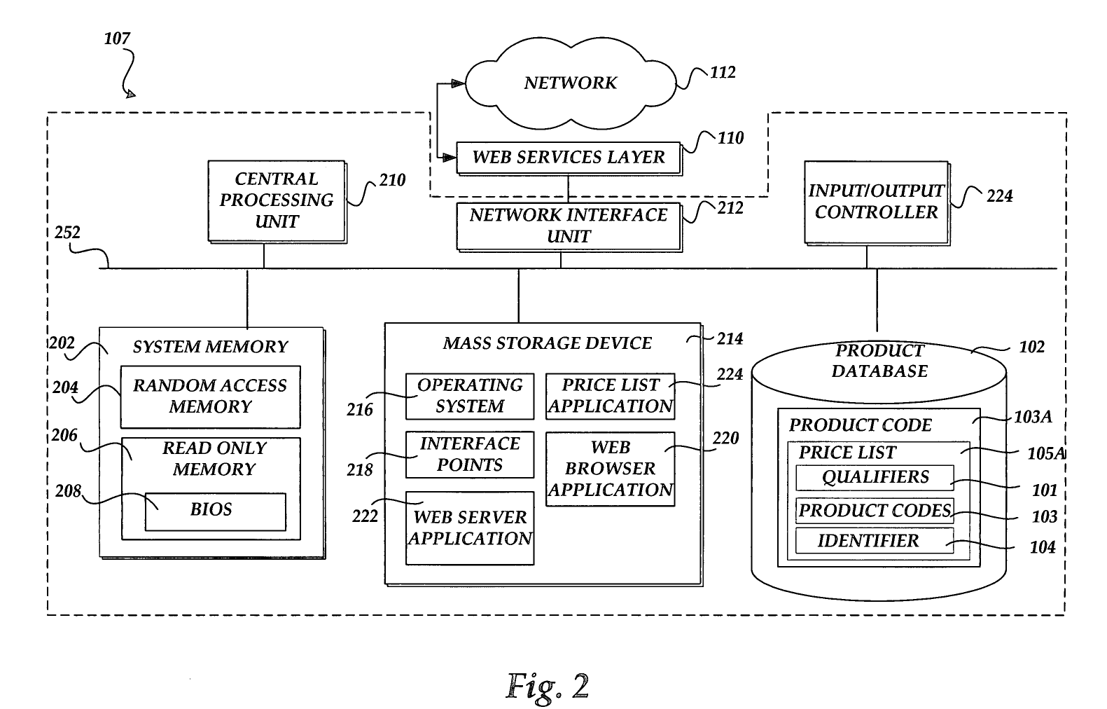

With reference to FIG. 2, the PDS 107 includes the database 102, a central processing unit (CPU) 210, a system memory 202, and a system bus 252 that couples the system memory 202 to the processing unit 210. The system memory 202 includes read-only memory (ROM) 206 and random access memory (RAM) 204. A basic input/output system 208 (BIOS), containing the basic routines that help to transfer information between elements within the RMS 160, such as during start-up, is stored in ROM 206. The PDS 107 further includes a mass storage device (MSD) 214 for storing an operating system 216, a web server application 222, and other application programs, such as real-time interface points 218 developed in JAVA from SUN MICROSYSTEMS of Mountain View, Calif. for interfacing with entities that have access to the data arrangement stored in the database 102. The MSD 214 may also store a pricelist application 224 providing the business rule and qualifier logic and a web browser application 220 such as INTERNET EXPLORER from MICROSOFT CORPORATION of Redmond, Wash.

The MSD 214 is connected to the CPU 210 through a mass storage controller (not shown) connected to the system bus 252. The MSD 214 and its associated computer-readable media, provide non-volatile storage for the PDS 107. Although the description of computer-readable media contained herein refers to a mass storage device, such as a hard disk or CD-ROM drive, it should be appreciated by those skilled in the art that computer-readable media can be any available media that can be accessed by the CPU 210.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the CPU 210.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

According to various embodiments of the invention, the PDS 107 operates in a networked environment as shown in FIG. 1 using logical connections to remote computers through the network 112, such as the Internet, an Intranet, or a local area network (LAN). The PDS 107 may connect to the network 112 through the web services layer 110 via a network interface unit 212 connected to the system bus 252. The web services layer 110 may utilize a simple object access protocol (SOAP) to encode requests for and provisions of data before receiving or sending information over the network 112. It should be appreciated that the network interface unit 212 may also be utilized to connect to other types of networks and remote computer systems. The PDS 107 may also include an input/output controller 224 for receiving and processing input from a number of devices, including a keyboard or mouse (not shown). Similarly, the input/output controller 224 may provide output to a display screen, a printer, or other type of output device.

Referring still to FIG. 2, the pricelist application 224 in cooperation with the CPU 210 is operative to receive and respond to instructions via the real-time interface points 218 in real-time in order to create, update, and or retrieve data in the database 102. The database 102 may be an ORACLE database from ORACLE CORPORATION of Redwood, Calif. or an INFORMIX database from IBM CORPORATION of White Plains, N.Y. The database 102 is operative to store qualifier data elements 101 for each pricelist 105 defined for at least one product that may be referenced by a product code 103. Once a price for a product is fully qualified, an identifier 104, created as a concatenated key of the qualifiers 101 for the price of a product, is stored for referencing the pricelist 105. A pricelist 105 is the fully qualified price of a product once qualifier categories have been accounted. Additional details regarding qualifier categories will be described below with respect to FIGS. 3-5B.

FIG. 3 is a simplified block diagram illustrating qualifier categories presented and qualifiers received via the product maintenance graphical user interface (PMGUI) and the resulting data elements stored in the product database according to an embodiment of the present invention. The PMGUI 114 outlines at least three qualifier categories whereby a marketing representative or user may define pricelists 105 stored in the product database 102 by selecting the qualifiers 101 necessary to qualify a price. Defining the pricelists 105 includes establishing one or more qualifiers 101 for determining a price of products associated a pricelist. Each qualifier 101 established for a pricelist 105 is an attribute of the pricelist that results in a price variation for the product being offered. Most qualifiers are covered by at least one of the three categories described. A customer type category 302 designates characteristics of the customer defined by one or more business rules. For example, customers that spend over a threshold quantity on telecommunications products may be designated as being a ‘GOLD’ type customer. In addition or in the alternative, customers who have been purchasing products for a certain period of time may also receive a certain customer type status. As illustrated, the qualifier 101A for the customer type category 302 has been designated as ‘GOLD’.

A location category 304 designates a location of the customer, for example a state 303 where the customer resides and/or a location of a wire center 305 servicing the customer in the case of a telecommunications product. As illustrated, the location qualifier 101B has been designated as ‘ALABAMA’. The location category is further designated by a qualifier 101C for a wire center location designated as ‘BIRMINGHAM’. The location category 304 may also include the city where the customer resides as well as the county or region. The number of qualifiers to fully qualify a price may be unlimited.

Additionally, a product type category 307 designates a product purchased by the customer that anchors prices the customer pays for other products. For example, customers that purchase premium products may qualify for different pricelists 105 than customers that purchase entry products. Thus, when a qualifier 101D for the product type category 307 has been designated as purple bundle ‘PBUN’, customers that have purchased PBUN products qualify for the prices listed in pricelist 105A for products and product components associated with the pricelist 105A. PBUN may be defined by other products such as call waiting, call screening, and wireless service. When a customer purchases PBUN, the customer qualifies for pricelists 105 that designate PBUN as a qualifier 101D for the product category 307. Thus, when the customer orders a new product that is associated with a pricelist 105 designating PBUN as a qualifier, the customer receives a price discount because they have purchased PBUN.

The qualifiers are received via the PMGUI 114 by the PDS 107 server (not shown) and stored in the product database 102. The data arrangement in the product database 102 includes the pricelist 105A qualified by the price qualifiers 101 and associated with the product code 103A. In this case the product code 103A represents a product called ‘Call Forwarding Blue’. The data arrangement also includes a tag 308 and a tag value 104A. The tag 308 identifies the tag value 104A as a pricelist identifier referencing the pricelist 105A. The tag value or pricelist identifier 104A is the concatenated key encoding the designated qualifiers 101 for the pricelist 105A. In this case the pricelist identifier is ‘X112K’.

It should be appreciated that designated qualifiers for each pricelist are associated in a hierarchical relationship. For example, the qualifier for the wire center 305 serves as a sub-qualifier for the state 303 such that a pricelist 105 without a wire center qualifier 101C, but having a state qualifier 101B, inherits the properties associated with the higher level or broader qualifier, in this case the state qualifier 101B. Thus, a product without a wire center qualifier will inherit the properties of being located anywhere in the state, in this case ‘Alabama’. Similarly, pricelists without a state qualifier, thereby creating a null value in 101B, will inherit the properties of being located anywhere, if the state qualifier 101B is the highest level for the customer location qualifier category 304. A pricelist 105 with a null value for the customer location qualifier category 304 will be qualified based on the customer type qualifiers and/or the product qualifiers located anywhere. Other examples include a single product, such as call waiting, may be a sub-qualifier for a wireline product package. The wireline product package may in turn serve as a sub-qualifier for a product bundle including wireline and wireless products. Additional details regarding defining pricelists 105 will be described below with respect to FIGS. 4A-5B.

FIGS. 4A-4C are computer screen displays showing an illustrative PMGUI 114 for creating and displaying pricelists according to an embodiment of the present invention. FIG. 4A is a screen display 400 illustrating the PMGUI 114 where a user may select the pricelist tab 402 to define, create, or update a pricelist 105. Next the user may select a ‘Qualified Product Type’ 404 for a Category Selection Menu. The qualified product type, in this case Internet service, determines what qualifiers are available to fully qualify the pricelist defined.

FIG. 4B is a screen display 407 of the PMGUI 114 where a user may enter values for the various qualifiers available for the qualified product type 404. The user may initiate data element entry by selecting the new button 408 thereby displaying text boxes and menus. The sales channel qualifier 412 may differentiate the price of the product 103. The sales channel may be a phone order, an Internet order, a third party order, or other negotiation channel. The customer type qualifier 302 may also be entered to differentiate the price of the product. Next the location category qualifiers for state 303 and wire center 305 may be entered to vary the price. Additionally, a product category qualifier 307 may be entered in the form of a product bundle. Once the necessary qualifier values have been entered, the user applies the qualifiers to the pricelist by selecting the apply button 414 and the save button 417.

FIG. 4C is a screen display 410 illustrating the tag 308 ‘ZPRL’ indicating a pricelist and various pricelist identifiers 104A, 104B, and 104C for pricelists 105 defined via the PMGUI 114. Each identifier represents a different pricelist 105 having varied qualifiers 101 that differentiate the price of associated products. Additional details regarding assigning products, product components, and setting prices will be described below with respect to FIGS. 5A-5B.

FIGS. 5A-5B are computer screen displays showing an illustrative PMGUI 114 for creating and displaying pricelists lines according to an embodiment of the present invention. FIG. 5A illustrates the screen display 520 for a user to enter a price for the products associated with the pricelist defined. The screen display 520 is accessed by retrieving a defined pricelist and selecting the new button 408. The product code 103 may be selected by the link 524 showing the available products to associate with the pricelist. As described briefly above, it should be appreciated that multiple products may be associated with a single pricelist.

Next a list line type 526 may be selected, in this case for price. Other list line types 526 may include percentages and non-monetary benefits, such as bonus usage minutes. The price type 528 is further defined by selecting a price component category such as base price, recurring charge, non-recurring charge one time charge, activation charge, shipping and handling charge, installation charge, connection charge, savings amount, savings percentage, savings benefit, discount price, or usage price or other price components. A business code 530 and description 532 of the pricelist line maybe also be entered. The description 532 may be used in the text of a bill to describe price saving features. Further, the price 534 of the product or product component referenced by the product code 103 is entered. An indicator as to whether the price is eligible for being waived may also be entered. A start date 538 and an end date 540 of the price are also entered to facilitate activation and expiration. The entries are applied and saved by selecting the apply button 414 and the save button 417.

FIG. 5B shows a screen display 550 illustrating various products associated with the pricelist referenced by the pricelist identifier 104A ‘X1112K’. Each product is referenced by the product codes 103 and associated with a price 534. The price types 528 in this case are all recurring rates.

Once the data elements are entered via the PMGUI 114 pricelists for products and product bundles will be created in the product database 102 in the form of a product catalog as illustrated in the following tables.

TABLE 1
PBUN (Purple Bundle). Single Price Point

| | Product | Price Lists Prices | |
|---|---|---|---|
| Description | Code/USOC | X1112K Price | X1114N Price |
| Purple Bundle | PBUN | $27 | $30 |
| Wireline Component | 1FR | | |
| BSLD Component | BSLBB | | |
| Wireless Component | CINBB | | |

TABLE 2
GBUN (Green Bundle). Component Priced

| | Product | Price Lists Prices | |
|---|---|---|---|
| Description | Code/USOC | X1112K Price | X1114N Price |
| Green Bundle | GBUN | | |
| Wireline Component | 1FR | $20 | $25 |
| Wireline Component | ESC | $1 | $1 |
| BSLD Component | BSLBB | $5 | $7 |
| Wireless Component | CINBB | $10 | $15 |
| DotNet Component | DNBB | $30 | $35 |

TABLE 3
CFB (Call Forwarding Blue). Component Priced

| | | Price List Prices | | | |
|---|---|---|---|---|---|
| | | X1112K | | X1114N | |
| | Product | Price | | Price | |
| Description | Code/USOC | RC | NRC | RC | NRC |
| Premium Call Forwarding | ESC | $5 | $1 | $7 | $0 |
| Wireline Component | | | | | |

Table 1 illustrates a product defined by other products in the form of a product bundle called PBUN. In this case PBUN is defined by a wireline, a long distance, and a wireless component combined in a bundle grouping. The individual components may comprise individual products or product packages including a plurality of individual products. PBUN is associated with two pricelist in the product database 102. PBUN has a single price point, meaning that the grouping of products is priced as a whole. On one pricelist referenced by the pricelist identifier ‘X1112K’, the price for PBUN is $27 and on the other pricelist referenced by ‘X1114N’ the price is $30.

Similarly, in table 2 the product Green Bundle (GBUN) is defined by other products and associated with two pricelists, however GBUN is component priced. Component pricing, prices the individual components of GBUN based on being a part of GBUN. Thus a customer who purchases GBUN and meets the qualifications for the pricelist referenced by the pricelist identifier X1112K will receive the wireless component for $10. Another customer purchasing GBUN and meeting the qualifications for the pricelist referenced by the pricelist identifier X1114N will receive the wireless component at a higher price of $15 due to the varied qualifiers.

Table 3 illustrates a single product, Premium Call Forwarding for wireline service (ESC), not defined by other products. Here the price of non-recurring (NRC) and recurring (RC) charges are illustrated, differentiating in price based on the qualifiers associated with each pricelist. Upon receiving an order inquiry for any product, a customer service representative, via the customer service interface applications 115, may retrieve a price quote from the product database 102 base on the qualifiers 101 and product code 103 requested. Also, upon executing an order the customer service representative may add the product code and the pricelist identifier to the customer records 108.

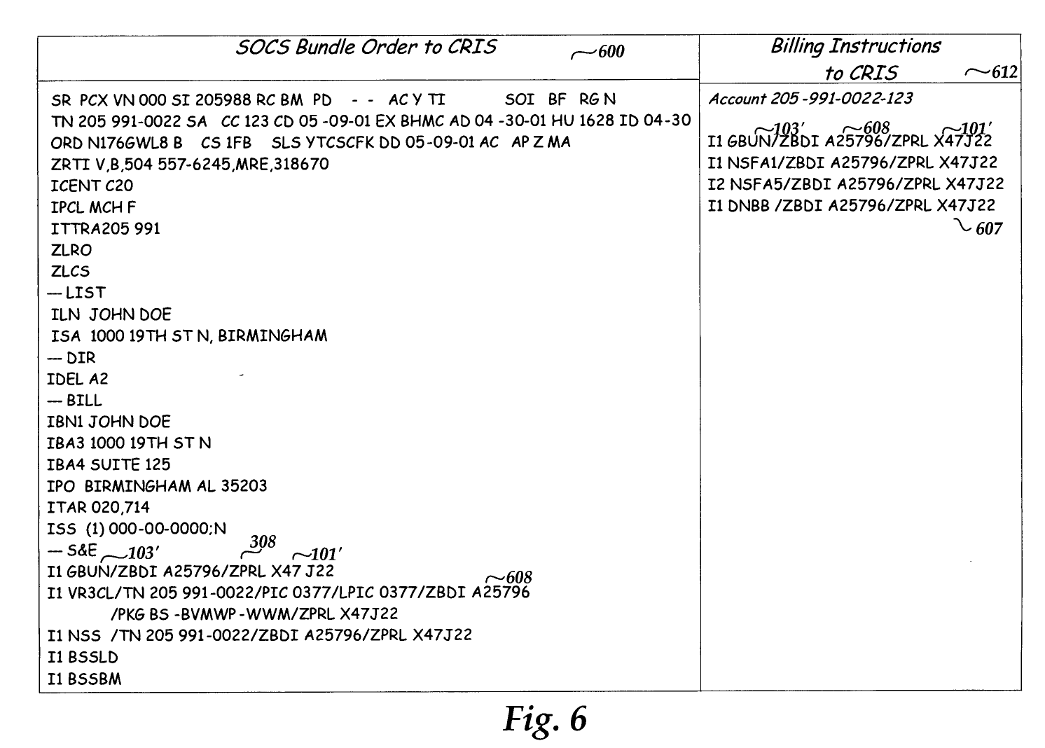

FIG. 6 illustrates a sample service order 600 with billing instructions 612 generated upon executing an order for a product priced by a pricelist according to an embodiment of the present invention. The service order 600 includes the product code 103′ associated with the field identifier tag 308 ZPRL that signals a pricelist and the pricelist identifier 101′. When a product needs to be rated for billing purposes, the pricelist identifier 101′ identifiers the row in the pricelist where the price associated with the product code is found. The following table illustrates the information that billing has access to due to the pricelist identifier.

TABLE 4
Product Information Sent to Rating/Billing

| | Product | | | | | | | |
|---|---|---|---|---|---|---|---|---|
| | Component | | | | Requires | Revenue | Account | Print |
| Product | Code | Price List ID | Price | Entity | Activation? | Allocation | Code | Description |
| PBUN | PBUN | X1112K | $27 | N/A | N | N/A | ? | Purple |
| | | | | | | | | Bundle for |
| | | | | | | | | Silver |
| | | | | | | | | Customers |
| PBUN | 1FR | X1112K | $0 | BST | N | 10% | abc | |
| PBUN | BSLBB | X1112K | $0 | BSLD | N | 50% | def | |
| PBUN | PBUN | X1114N | $30 | N/A | N | N/A | ? | Purple |
| | | | | | | | | Bundle for |
| | | | | | | | | Gold |
| | | | | | | | | Customers |
| PBUN | 1FR | X1114N | $0 | BST | N | 10% | abc | |
| PBUN | BSLBB | X1114N | $0 | BSLD | N | 50% | def | |
| PBUN | CINBB | X1114N | $0 | Cing | Y | 40% | hij | |
| GBUN | GBUN | X1112K | $0 | N/A | N | N/A | ? | Green |
| | | | | | | | | Bundle |
| GBUN | 1FR | X1112K | $20 | BST | N | $20 | abc | |
| GBUN | ESC | X1112K | $1 | BST | N | $1 | nop | |
| GBUN | BSLBB | X1112K | $5 | BSLD | N | $5 | def | |
| GBUN | CINBB | X1112K | $10 | Cing | N | $10 | hij | |
| GBUN | DNBB | X1112K | $30 | dotNet | N | $30 | klm | |
| GBUN | GBUN | X1114N | $0 | N/A | N | N/A | ? | Green |
| | | | | | | | | Bundle |
| GBUN | 1FR | X1114N | $25 | BST | N | $25 | abc | |
| GBUN | ESC | X1114N | $1 | BST | N | $1 | nop | |
| GBUN | BSLBB | X1114N | $7 | BSLD | N | $7 | def | |
| GBUN | CINBB | X1114N | $15 | Cing | N | $15 | hij | |
| GBUN | DNBB | X1114N | $35 | dotNet | N | $35 | klm | |
| ESC | ESC | X1112K | $0 | N/A | N | N/A | nop | Premium |
| | | | | | | | | Call |
| | | | | | | | | Forwarding |
| ESC | ESC-RC | X1112K | $5 | BST | Y | $5 | nop | Recurring |
| | | | | | | | | Charge |
| ESC | ESC-NRC | X1112K | $1 | BST | Y | $1 | nop | Non- |
| | | | | | | | | Recurring |
| | | | | | | | | Charge |
| ESC | ESC | X1114N | $0 | N/A | N | N/A | nop | Premium |
| | | | | | | | | Call |
| | | | | | | | | Forwarding |
| ESC | ESC-RC | X1114N | $7 | BST | Y | $7 | nop | Recurring |
| | | | | | | | | Charge |
| ESC | ESC-NRC | X1114N | $0 | BST | Y | $0 | nop | Initial Fee |
| | | | | | | | | Waived |

The information includes, among other features, the product code, the product component code, the pricelist identifier and description language that may be on the printed bill describing savings qualifiers. For example a description could read as follows: “Due to your status as a silver customer you have saved $5 on your purchase of PBUN”.

The logical operations of the various embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

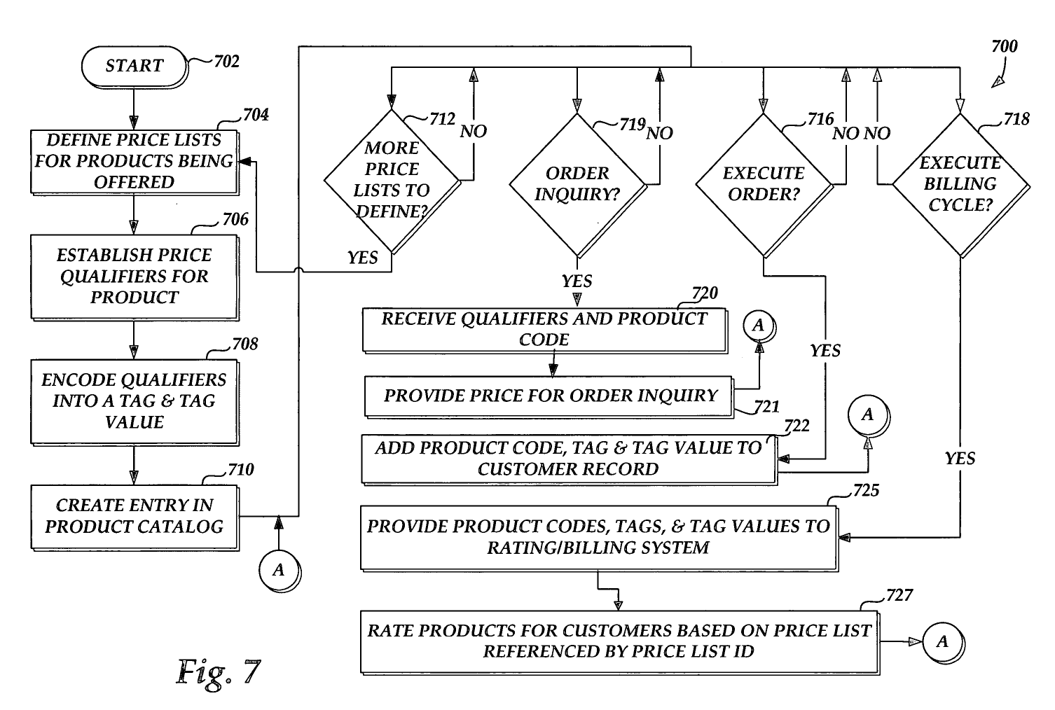

FIG. 7 illustrates a flow diagram showing an illustrative routine 700 for pricing products utilizing pricelists based on qualifiers according to an embodiment of the present invention. The routine 700 begins at start operation 702. The routine 700 then continues to operation 704 where one or more pricelists 105 are defined for products being offered. Next the routine 700 continues to operation 706 where defining a pricelist 105 includes establishing one or more qualifiers 101 for determining a price of the product. Each qualifier established for the pricelist 105 is an attribute of the pricelist 105 that results in a price variation for the product being offered.

The routine 700 then continues to operation 708 where the qualifiers 101 necessary to fully qualify a price of the product are encoded into a pricelist identifier 104 referencing the price list 105. Each pricelist 105 includes a price of the product once the qualifiers 101 necessary to fully qualify a price have been established. The number of qualifiers available to differentiate the price of a product may be unlimited. The routine 700 then continues to operation 710 where an entry associating the product with the pricelist is created in the product database 102 in the form of a product catalog entry. The entry is available for retrieval in response to inquiries and executed orders.

The routine 700 then asynchronously continues to operations 712, 719, 716, and 718 described below. At operation 712, a determination is made as to whether more pricelists 105 are to be defined. This may be in response to the selection of the pricelist tab 402 via the PMGUI 114. When more pricelists are to be defined the routine 700 returns to operation 704 described above.

At operation 719, a determination is made as to whether an order inquiry has been received. When order inquiries are received, the routine 700 continues to operation 720. At operation 720 the qualifiers and product code of the order inquiry are received. The receipt of the qualifiers and product code may be via the customer service interface applications 115. In response to receiving the qualifiers and product code, the routine 700 continues to operation 720 where a price is provided based on the received qualifiers for the product represented by the received product code. The routine 700 then asynchronously returns from operation 721 to operations 712, 719, 716, and 718.

At operation 716, a determination is made as to whether an order has been executed. When an order is executed, the routine 700 continues to operation 722 where the product code ordered and the field and pricelist identifiers are added to the customer records 108 and the service order 600. The routine 700 then continues from operation 722 to operations 712, 719, 716, and 718.

At operation 718, a determination is made as to whether a billing cycle is being executed. When a billing cycle is being executed, the routine 700 continues to operation 725. At operation 725, billing instructions 612 including the product codes 103 and the pricelist identifiers 104 are sent to the billing rating system 120. The routine 700 then continues from operation 725 to operation 727. At operation 727, the products are rated based on the pricelist 105 referenced by the pricelist identifier 104 associated with the rated product code 103. The routine 700 then continues to operations 712, 719, 716, and 718 described above.

Thus, the present invention is presently embodied as a method, system, computer program product or computer readable media encoding a computer program for pricing products utilizing pricelist based on qualifiers.

It will be apparent to those skilled in the art that various modifications or variations may be made in the present invention without departing from the scope or spirit of the invention. Other embodiments of the invention will be apparent to those skilled in the art from consideration of the specification and practice of the invention disclosed herein.

1. A method of pricing products based on qualifiers, comprising;
defining at least one pricelist for a product being offered, wherein defining the pricelist includes establishing one or more qualifiers for determining a price of the product and wherein each qualifier established for the pricelist comprises an attribute of the pricelist that results in a price variation for the product being offered; and
encoding the qualifiers necessary to fully qualify a price of the product into a pricelist identifier referencing the price list wherein the pricelist comprises a price of the product once the qualifiers necessary to fully qualify a price have been established whereby prices of the product may be differentiated based on an unlimited number of qualifiers.

2. The method of claim 1, wherein each qualifier necessary to fully qualify a price of the product is associated with at least one of the following qualifier categories:
a customer type category;
a location category; and
a product category.

3. The method of claim 2, wherein qualifiers available for each pricelist are associated in a hierarchical relationship such that some of the qualifiers available serve as a sub-qualifier for other broader qualifiers of the qualifiers available such that a pricelist having an undesignated sub-qualifier, but having a designated broader qualifier associated with the undesignated sub-qualifier, inherits properties associated with the designated broader qualifier and wherein defining the pricelist further includes at least one of the following:
establishing a qualified product type for the pricelist defined, wherein the qualified product type determines what qualifiers are available for the pricelist;
establishing a customer type as a qualifier, wherein the customer type is determined based on at least one predetermined business rule; and
creating a price list line that provides a price for the product based upon the price list.

4. The method of claim 3, wherein creating a price list line comprises:
selecting the product for which to provide a price wherein the product is represented by a product code;
selecting a price type; and
entering a price for the product.

5. The method of claim 4, wherein creating a price list line further comprises:
selecting a list line type;
entering a business code for the product;
entering a description of the price list line;
selecting whether the price entered is waived; and
entering at least one of a start date and an end date of the price list line.

6. The method of claim 3, wherein defining a pricelist further includes establishing at least one of the following as qualifiers:
a sales channel;
a state location;
a wire center; and
a product bundle.

7. The method of claim 1, wherein multiple pricelists are defined for the product being offered and wherein each pricelist defined comprises a price of the product once necessary qualifiers to fully qualify a price are established.

8. The method of claim 1, wherein multiple products are priced utilizing the price list.

9. The method of claim 1, wherein the pricelist includes at least one of the following:
a recurring charge;
a non-recurring charge;
a usage charge;
a one time charge;
a base price;
an activation charge;
a shipping and handling charge;
an installation charge;
a connection charge;
a savings amount;
a savings percentage; and
a savings benefit.

10. The method of claim 1, wherein the product comprises a combination of other products and wherein each other product comprises a component of the price list represented by a pricelist line wherein a pricelist line provides a price for the component based upon the pricelist in which a pricelist line exists.

11. The method of claim 10, wherein the product is component priced based on each component of the price list.

12. The method of claim 10, wherein the product is priced as a single price point comprising the combination of other products.

13. The method of claim 1, wherein the pricelist identifier comprises a concatenated key of the qualifiers necessary to fully qualify a price of the product, the concatenated key having a tag value with a preceding tag for identifying the tag value and the pricelist whereby an application seeking a price of the product is driven to the pricelist.

14. The method of claim 13, further comprising creating an entry for the product in a product catalog wherein the entry includes at least one of the following:
the qualifiers necessary to fully qualify a price of the product;
a pricelist associated with the product;
a pricelist identifier referencing the pricelist; and
a product code representing the product.

15. The method of claim 14, further comprising:
in response to receiving an order inquiry including inquiry qualifiers and an inquiry product code, querying the entry in the product catalog for a first match between the product code and the inquiry product code and a second match between the inquiry qualifiers and the qualifiers necessary to fully qualify a price of the product; and
in response to querying the entry and finding the first and the second match, returning a price of the product based on the order inquiry.

16. The method of claim 14, further comprising:
in response to an order for the product being executed for a customer, adding the product code, the tag, and the tag value to a record for the customer.

17. The method of claim 16, wherein the product code comprises a universal service order code, the tag comprises a field identifier, and the tag value comprises field data.

18. The method of claim 16, further comprising in response to executing a billing cycle for the customer:
providing the product code, the tag, and the tag value to a rating/billing system; and
rating the product by accessing the pricelist referenced by the tag value provided to the rating/billing system.

19. The method of claim 1, wherein the product comprises at least one of the following:
a telecommunication product;
a telecommunication service;
a cable communications product;
a satellite communications product; and
an Internet product.

20. The method of claim 19, wherein at least one of the telecommunication product and the telecommunication service comprises at least one of the following:
a wireless communication service;
a wireline communication service;
a broadband communication service;
a voice over Internet service;
a wireline and wireless service;
a long distance service;
a call screening service;
a call forwarding service; and
a data messaging service.

21. A computer readable medium containing computer executable instructions which when executed by a computer perform the method of claim 1.

22. A computer-controlled apparatus capable of performing the method of claim 1.

23. A computer-implemented system for pricing products based on qualifiers, comprising;
a server computer providing a graphical user interface operative to receive data to define at least one pricelist for a product being offered, wherein defining the pricelist includes establishing one or more qualifiers for determining a price of the product and wherein each qualifier established for the pricelist comprises an attribute of the pricelist that results in a price variation for the product being offered; and
wherein the server computer is further operative to encode the qualifiers necessary to fully qualify a price of the product into a pricelist identifier referencing the price list wherein the pricelist comprises a price of the product once the qualifiers necessary to fully qualify a price have been established whereby prices of the product may be differentiated based on an unlimited number of qualifiers; and
a database operative to store at least one entry for the product in a data arrangement wherein the entry includes at least one of the following:
the qualifiers necessary to fully qualify a price of the product;
a pricelist including a fully qualified price associated with the product;
a pricelist identifier referencing the pricelist; and
a product code representing the product.

24. The computer-implemented system of claim 23, wherein each qualifier necessary to fully qualify a price of the product is associated with at least one of the following qualifier categories:
a customer type category;
a location category; and
a product category.

25. The computer-implemented system of claim 23, wherein qualifiers available for each pricelist are associated in a hierarchical relationship such that some of the qualifiers available serve as a sub-qualifier for other broader qualifiers of the qualifiers available such that a pricelist having an undesignated sub-qualifier, but having a designated broader qualifier associated with the undesignated sub-qualifier, inherits properties associated with the designated broader qualifier and wherein the graphical user interface is operative to receive inputs for at least one of the following:
establishing a qualified product type for the pricelist defined, wherein the qualified product type determines what qualifiers are available for the pricelist; and
establishing a customer type as a qualifier, wherein the customer type is determined based on at least one predetermined business rule; and
creating a price list line that provides a price for the product based upon the price list.

26. The computer-implemented system of claim 25, wherein creating a price list line comprises:
selecting the product for which to provide a price wherein the product is represented by a product code;
selecting a price type; and
entering a price for the product.

27. The computer-implemented system of claim 23, wherein at least one of multiple pricelists are defined for the product being offered and multiple products are priced utilizing the price list.

28. The computer-implemented system of claim 23, wherein the pricelist includes at least one of the following:
a recurring charge;
a non-recurring charge;
a usage charge;
a one time charge;
a base price;
an activation charge;
a shipping and handling charge;
an installation charge;
a connection charge;
a savings amount;
a savings percentage; and
a savings benefit.

29. The computer-implemented system of claim 23, wherein the product comprises a combination of other products and wherein each other product comprises a component of the price list represented by a pricelist line wherein a pricelist line provides a price for the component based upon the pricelist in which a pricelist line exists.

30. The computer-implemented system of claim 29, wherein the product is one of component priced based on each component of the price list and priced as a single price point comprising the combination of other products.

31. The computer-implemented system of claim 23, wherein the pricelist identifier comprises a concatenated key of the qualifiers necessary to fully qualify a price of the product, the concatenated key having a tag value with a preceding tag for identifying the tag value and the pricelist whereby an application seeking a price of the product is driven to the pricelist.

32. The computer-implemented system of claim 23, further operative to:
in response to an order for the product being executed for a customer, add the product code, the tag, and the tag value to a record for the customer.

33. The computer-implemented system of claim 32, wherein the product code comprises a universal service order code, the tag comprises a field identifier, and the tag value comprises field data.

34. The computer-implemented system of claim 32, further comprising a rating/billing system, the compute implemented system further operative in response to executing a billing cycle for the customer to:
provide the product code, the tag, and the tag value to the rating/billing system; and
rating the product by accessing the pricelist referenced by the tag value provided to the rating/billing system.

35. A pricelist defined for at least one product comprising a data arrangement including:
at least one price for the product based on a number of qualifiers necessary to fully qualify the price wherein each qualifier comprises an attribute of the pricelist that results in a price variation for the product and wherein the number of qualifiers are unlimited;
a pricelist identifier comprising a concatenated key of the qualifiers such that the pricelist is referenced by other applications via the pricelist identifier; and
a product code associating the product with the pricelist such that applications seeking a price of the product and having the product code and the pricelist identifier retrieves the price from the pricelist without knowledge of the qualifiers necessary to fully qualify the price.
